(19) United States
(12) Patent Application Publication
(10) Pub. No.: US 2022/0138820 A1
(43) Pub. Date: May 5, 2022

(54) DATA-DRIVEN SALES RECOMMENDATION TOOL

(71) Applicant: EMC IP Holding Company LLC, Hopkinton, MA (US)

(72) Inventors: Noga Gershon, Dimona (IL); Amihai Savir, Sansana (IL); Avitan Gefen, Tel Aviv (IL)

(21) Appl. No.: 17/084,327

(22) Filed: Oct. 29, 2020

(51) Int. Cl. G06Q 30/06; G06N 20/00; G06Q 10/06; G06F 17/18

(52) U.S. Cl. CPC G06Q 30/0611; G06F 17/18; G06Q 10/06375; G06N 20/00

(57) ABSTRACT

One example method includes receiving a quote for provision of goods and/or services, and the quote concerns a particular account, receiving information concerning characteristics of the account identified in the quote, receiving information concerning characteristics of the goods and/or services specified in the quote, generating a probability that the quote will be approved by the account, and the probability is generated based on the characteristics of the account and the characteristics of the goods and/or services specified in the quote, when the probability is below a threshold, generating an adjusted quote based on input received, and generating an updated probability based on the adjusted quote.

### FIELD OF THE INVENTION

Embodiments of the present invention generally relate to data analysis. More particularly, at least some embodiments of the invention relate to systems, hardware, software, computer-readable media, and methods for using both historical data and user-specified constraints to generate a data set having a corresponding probability of being accepted by the user.

### BACKGROUND

In modern competitive markets, whether for services or products, it can be important for an enterprise to be able to anticipate the needs of its customers precisely and quickly. A mistaken understanding of customer needs, and/or a failure to timely understand those needs, could result in lost opportunities for the enterprise. To illustrate, a salesman may have a limited ability to evaluate the likelihood that a particular proposal would be approved by a customer. This limited ability may be due, for example, to a lack of evaluative capabilities and resources, and/or to a lack of relevant data. Further, even where a salesman may be able to formulate a proposal, modification of the proposal, with the aim of the proposal being approved according to some constrains, can be a complex task which requires time as well as a deep understanding of the various different components of the proposal.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of a machine learning (ML) model according to some example embodiments.

FIG. 2 discloses aspects of an example scenario involving determination of a probability of acceptance.

FIG. 3 discloses aspects of another example scenario involving determination of a probability of acceptance.

FIG. 4 is a flow diagram disclosing aspects of an example method.

FIG. 5 discloses aspects of an example computing entity that may be configured to perform any of the disclosed methods and processes.

### DETAILED DESCRIPTION OF SOME EXAMPLE EMBODIMENTS

Embodiments of the present invention generally relate to data analysis. More particularly, at least some embodiments of the invention relate to systems, hardware, software, computer-readable media, and methods for using both historical data and user-specified constraints to generate a data set having a corresponding probability of being accepted by the user. Some particular embodiments are directed to prediction of the probability that a particular proposed agreement will be accepted by a party, although the scope of the invention is not limited to this particular application.

In general, at least some example embodiments of the invention may employ a data driven approach that applies a machine learning model on historical data and predicts the probability that a proposed agreement, or quote, generated by a sales entity will be accepted by a particular customer entity. The sales entity may be associated with an enterprise that offers products and/or services for sale to one or more customers. In some instances, a customer entity may comprise a computing system programmed, for example, to evaluate the quote in light of such parameters as customer-specified constraints.

In cases where the probability of the acceptance of a quote proposal may be relatively low, the system may recommend actions, such as modification of the quote proposal, to be taken in order to increase the attractiveness of the offer so as to correspondingly increase the probability that the quote will be accepted by the customer entity. Such actions may include, for example, upgrading some products, and/or replacing items with equivalent ones so that a bigger discount can be given. These actions may be selected on various bases, such as with a view to minimizing the impact on an expected margin associated with the quote, and/or with regards to constraints imposed by the sales entity and/or the customer entity. Example embodiments may employ various mechanisms to these ends. To illustrate, example embodiments may employ a machine learning model, which may be based on and/or employ historical data, that may help to estimate the probability that a particular quote will be approved by the customer entity to whom the quote is proposed. Another mechanism that may be employed in some embodiments is a mechanism that may help construct a better quote based on constraints imposed by the customer, as well as constraints imposed by the sales entity. A proposal may embrace a proposed quote or transaction between/among two or more parties, such as a sales entity and customer entity, for example. A proposal may, or may not, actually be implemented between/among the parties.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that an embodiment, such as a sales entity, may employ historical information concerning prior dealings with a customer entity and/or constraints imposed by the customer entity to generate a proposal with a relatively high, or relatively higher, likelihood of acceptance by the customer entity. An embodiment may measure the likelihood of acceptance with reference to a scale such as a numerical scale, and/or with respect to the respective likelihoods of acceptance of one or more other proposals that may have been generated by the sales entity, by the customer entity. An embodiment may enable modification of an existing proposal to create a proposal with a relatively higher likelihood of acceptance. An embodiment of the invention may take into consideration, such as in the form of an input to a computer performed process, human insights and/or other human-generated data as a basis for generating a new or modified proposal. Embodiments of the invention embrace methods and processes that are beyond the ability of a human to perform, practically or even at all, as a mental process, and such methods and processed performed in connection with embodiments of the invention may employ various combinations of factors and data to generate new/modified proposals. As such, these methods and processes may be performed quickly, effectively, and without introduction of human error in such performance.

### A. Overview

The following is a discussion of aspects of example operating environments for various embodiments of the invention. This discussion is not intended to limit the scope of the invention, or the applicability of the embodiments, in any way.

Competition today is as fierce as ever due to the abundance of competitors in the goods and services markets. In order to stay a major contestant in this competitive landscape, companies should offer their customers the best possible prices, quantity and quality of goods and services before their competitors are able to do so. Typically, however, salespersons use only their own human intuition to estimate the likelihood that a proposal will be accepted by a customer. Offering a proposal that may be relatively likely to be rejected might waste precious time and lead to the acceptance, by the target customer, of a better deal made by a competitor company.

In more detail, a salesman typically relies primarily, or even exclusively, on his intuition in constructing a quote that, the salesman hopes, will approved by the customer. This approach may be rather tricky however, since intuition is different between people and may grow, develop, and change, as experience is gained by the salesman. An incorrect assessment of the likelihood that a quote will be approved by the prospective customer may result in lost opportunities. For example, while one offer is being rejected, a more appealing one, such as from a competitor, might appear and get approval from the customer before the initial offer could be adjusted to better meet the needs of the customer.

As well, it is a complex task to adjust parameters of a particular proposal, while still maintaining, for example, a desired margin, that is, a profit margin, for the proposal. In more detail, many proposals that are offered to customers are complex and composed of a variety of different components. Maintenance of a margin in an updated quote embraces any margin within plus/minus about 3% of the margin associated with the initial quote.

In addition, there may be many ways to improve a certain proposal without unduly reducing the margin associated with the proposal. However, the salesman may not necessarily have access to, or even be aware of the existence of, information concerning those possible avenues to improvement. Thus, the salesman may have little recourse in terms of the data that is available to be used as a basis for adjusting a proposal. In some cases, for example, the desired margin for the proposal may be the only information available to the salesman. A simplistic approach to proposal construction/modification, such as one that relies largely or exclusively on margin information, will likely be inadequate to produce a proposal with an acceptable likelihood of acceptancy by the target customer.

Moreover, manual adjustment to a proposal, such as may be performed by a salesman, will likely not produce acceptable results since a manual process is too slow, complex, and/or susceptible to human error, to generate the proposal in an accurate and timely manner. For example, a manual process would require a trial and error, rather than systematic, approach, to proposal creation/modification. Such a trial and error approach may prolong the time between the moment the target customer approached the company of the salesman and the moment an offer is proposed to the target customer. As noted earlier, such a delay may lead to lost sales opportunities.

### B. Aspects of Some Example Embodiments

With the foregoing considerations in mind, attention is directed now to aspects of some example embodiments. As noted earlier herein, embodiments of the invention may facilitate a process of constructing a quote, or proposal, while maximizing, or at least improving, the likelihood of approval of the proposal by the customer. Some example embodiments may include at least two mechanisms, namely, a machine learning model based on historical data that may help to estimate the probability that a particular proposal will be approved by the customer, and a second mechanism that may help construct a better quote, that is, one with a relatively high/higher likelihood of approval by a target customer, based on constraints imposed by the customer, and/or constraints imposed by the salesman. Thus, the second mechanism may be a mechanism that uses constraints and/or other input provided by the customer entity and/or the sales entity.

Embodiments of the invention may facilitate the process of constructing a proposal, while also maximizing, or at least improving, the odds of the approval of the proposal by the customer. Doing so can increase the competitiveness of the enterprise, and may increase the trust and satisfaction of the customers of the customer.

As described above, embodiments may employ two mechanisms that may support a process for generating/modifying a proposal. In some instances, each mechanism may employ a different respective data set. For the mechanism of predicting the probability that a proposal will be accepted, quote data may be employed which may contain information about product characteristics desired by the customer, as well as data concerning the account characteristics, that is, characteristics of the target customer for the proposal. The second mechanism may use data such as engineered product features of products produced by the enterprise. Because the extent to which product characteristics desired by the customer match those product features actually available from the enterprise may vary, the second mechanism can attempt to find the best match between what the customer wants and what is actually available. This concept may be illustrated by various products provided by Dell (https://www.dell.com/en-us/shop/dell-laptops/inspiron-14-3000-laptop/spd/inspiron-14-3480-laptop), where each available product and its selectable features are shown. Because the features may be individually selectable, a laptop, for example, may be defined that has a customized configuration specified by the user or purchaser.

It was noted earlier that various data may be used in connection with embodiments of the invention. As used herein, the term ‘data’ is intended to be broad in scope. Thus, that term embraces, by way of example and not limitation, data segments, data chunks, data blocks, atomic data, emails, objects of any type, files of any type including media files such as audio files and video files, word processing files, spreadsheet files, and database files, as well as contacts, directories, sub-directories, volumes, and any group of one or more of the foregoing. Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

Finally, as used herein, a ‘quote’ or ‘proposal’ refers to a potential transaction that may be proposed by a sales entity to a customer entity. Further, a ‘deal’ refers to a transaction that has been approved, that is, agreed to, by a customer. Thus, a quote or proposal may, or may not, ultimately end in a deal.

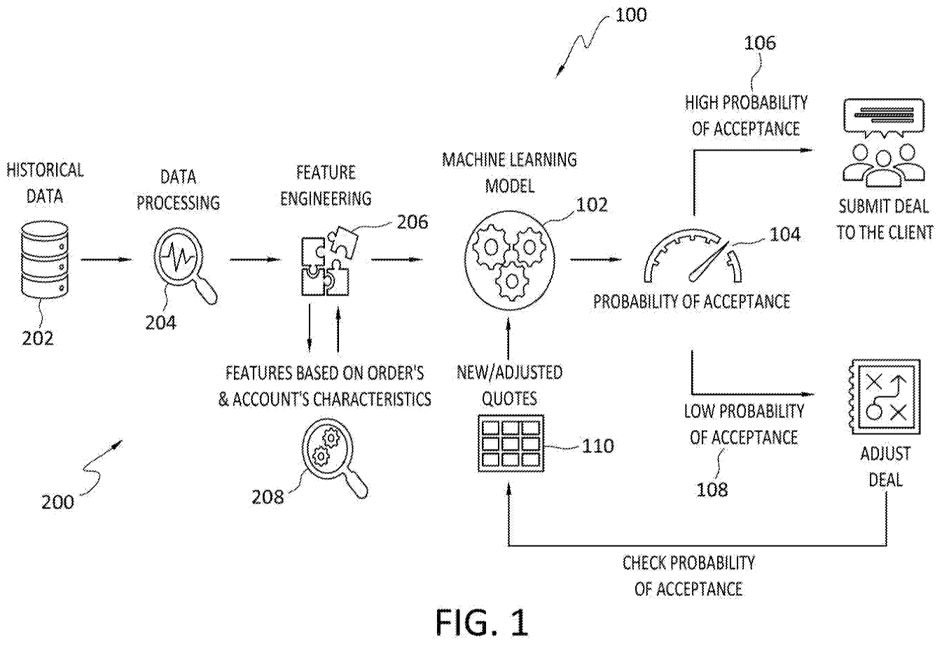

With particular attention now to FIG. 1, a scheme 100 is disclosed that may serve to generate new/modified proposals. In general, the example scheme 100 may include a machine learning model 102 that is operable to receive various inputs 103 based on which the machine learning model 102 may generate a probability score 104 that reflects an extent to which it is probable that a particular proposal will be accepted by a customer target. In the example of FIG. 1, a relatively high probability 106 may suggest that the proposal be submitted to the target customer, while a relatively low probability 108 may suggest that one or more aspects of the proposal should be adjusted to attempt to improve the probability, that is, an updated proposal 110 may be generated if the probability of acceptance is determined to be low or unacceptable.

The probability may, but need not necessarily be, expressed as a numerical value, such as a number in a range of 0 to 10, where zero indicates no probability that a proposal will be accepted, and 10 indicates certainty that the proposal will be accepted. A ‘high’ or ‘acceptable’ probability may be defined, for example, as a probability with a value of 7 or higher, and a ‘low’ or ‘unacceptable’ probably may be defined, for example, as a probability with a value of 6 or lower. The range, and expression, of probabilities may be embodied in any other suitable form, and the foregoing is provided only by way of example and is not intended to limit the scope of the invention in any way.

B.1 Aspects of an Example Machine Learning Model

With continued reference to FIG. 1, various data and processes 200 may be used to generate, and/or otherwise obtain and provide, input to the machine learning model 102. Such data may include historical data 202 which may be subjected to data preprocessing 204, and the historical data 202 may be used as a basis to engineer features 206 that may be included in products offered to customers. For example, if the historical data suggests that customers prefer hard drives of at least 1 Tb, the enterprise may decide to manufacture products that include hard drives of at least that size. The engineered features 206 may also be created and/or implemented based on order and/or account characteristics 208. For example, if the customer handles sensitive data, the customer may need data security features in any products that it purchases. The engineered features 206, which may be features available in the products of the enterprise, along with historical data 202, and/or, order/account characteristics, may all serve as inputs to the machine learning model 102.

With continued reference to FIG. 1, further details are provided concerning the example machine learning model 102. In order to build the machine learning model 102 for predicting the probability of the acceptance of a proposal, the quote characteristics identifying the needs of the customer, client/account characteristics 208, as well as similarity-based engineered features 206, and historical data 202, may be used as inputs to the model. The historical data 202 may be used as a direct input to the machine learning model 102 and/or as an input that may be used to inform development and engineering of the similarity-based engineered features 206.

As noted earlier, various historical data 202 may be employed as an input to a machine learning model 102. In at least some embodiments, historical data may comprise characteristics of one or more prior quotes, or proposals, that are associated with respective deals, and the historical data may additionally, or alternatively, comprise characteristics of one or more clients or customers that are associated with respective deals.

In more detail, deals may be clustered together in various ways. For example, body of input data for the machine learning model 102 may comprise one or more clusters of deals, where the clusters are defined based on similarities among quote characteristics of the quotes that underly those deals. That is, each deal in a group of deals may be associated with a respective set of one more quotes. Where quotes have similar characteristics, those quotes and, thus, the deals with which those quotes are associated, may be clustered together.

As another example, deals may be clustered together based on similarities among the accounts with which those deals are associated. That is, deals whose respective associated accounts have a particular degree of similarity with each other, may be clustered together.

The scope of the invention is not limited to the use of deal clusters based on quote characteristics, and account characteristics. More generally, deals may be clustered on any other additional, or alternative, bases, and the foregoing are provided only by way of example.

Either or both of the clusters concerning quote characteristics, and account characteristics, respectively, may be used to train the machine learning model 102 so that when a new quote or proposal is provided to the machine learning model 102, the machine learning model 102 may resort to these clusters of training data when generating a probability of acceptance for the new quote.

With reference first to quotes, clustering of deals based on quote information may be used to identify and capture similarity between quotes. For example, quotes may be determined to be similar to each other based on the products or services to which they relate, so that, for example, quotes relating to the same product, or service, may be deemed to be similar to each other.

For each deal in a cluster, to which one, some, or all, of the quotes relate, a ratio may be calculated of (deals)/(quotes). Such a deal ratio, or ratio of deals, may indicate, for example, which deals are reached relatively quickly in terms of the number of quotes needed before a deal was reached, and which deals took relatively longer to reach. In general, a ratio of 1 may be ideal, as it would indicate only 1 quote was needed to reach the deal, while a ratio of 0.2 for example, indicates that 5 quotes were needed before the deal was reached. Thus, the machine learning model 102 may choose to start with, or at least consider, the quote that corresponds to the ratio of 1, rather than the quote that corresponds to the ratio of 0.2, since the former quote was accepted more quickly. Because deals may be clustered together according to the similarity of the respective quote(s) to which they correspond, a comparison of the respective associated deal ratios for each deal may be useful.

When a new quote is generated, the new quote may be assigned to one of the deal clusters, based on similarity between the new quote and the quotes of the cluster. As well, an overall deal ratio of that cluster (total deals of cluster)/(total quotes in cluster) may be assigned to the new quote.

In addition to quote characteristics, account characteristics and similarities may also be used as an input to the machine learning model 102. That is, account-based training data for the machine learning model 102 may be generated by clustering deals together based on similarities among the characteristics of the respective accounts associated with those deals.

Thus, the training data may comprise the characteristics of various accounts, and the extent to which accounts may be similar to each other. Similarity of accounts may be determined on any suitable basis. For example, accounts may be determined to be similar if they each have a need for a particular product or service, if they each handle a particular type of data, or on any additional or alternative bases. More generally, similarity between accounts, and between quotes, may be defined based on any characteristic(s).

After the deals have been clustered based on the similarity of their respective underlying accounts, similarity measures among the deals in each cluster may be calculated. Calculation of similarity measures may be performed in any suitable way, and on any suitable bases. For example, if the characteristics of an account associated with a first deal are the same as the characteristics of an account associated with a second deal, which may be the case when the two accounts are actually the same account, then the similarity between the first and second deals may be 1.0. On the other hand, if the two accounts have 3 characteristics, out of a total of 7 each, that are the same, the similarity between the two deals may be expressed as ( 3/7) or 0.4. The similarity may be refined by weighting the characteristics of the accounts such that, for example, the fact that two accounts operate in the same markets may have relatively less weight than the fact that the two accounts typically buy the same types and numbers of computing equipment. Thus, one characteristic may be more influential than another characteristic in determining a deal similarity.

With continued reference to the deals clustered based on account similarity, a ratio of deals may be calculated, for example, using the 10 most similar deals as long as each deal has a similarity measure above 0.8. The foregoing values are provided only by way of example, and are not intended to limit the scope of the invention in any way. This approach may also be employed with respect to the clusters that include the quote characteristics. That is, a ratio of deals may be determined based upon a deal similarity that was determined with reference to the characteristics of the accounts respectively associated with those deals. When a new quote is generated, referring again to deals clustered based on account similarity, the new quote may be assigned to one of the deal clusters, and, as in the aforementioned illustrative case of 10 most similar deals, a ratio of deals calculated for that deal cluster to which the new quote was assigned.

The quote characteristics, and/or account characteristics, along with information concerning the engineered features, that is, the features available in products offered by the sales entity, may then be provided as inputs to the machine learning model 102. In some embodiments, the machine learning model 102 may comprise, or employ, a random forest learning method, which may also be referred to as a random decision forest. The machine learning model 102 may then process the aforementioned, and/or other, inputs to generate, as an output, a probability that a new/adjusted proposal, or quote, 110 will be approved by the target customer entity.

B.2 Aspects of Example Methods for Quote Adjustment

With continued reference to the example of FIG. 1, details are provided concerning an example framework for adjusting a quote with the purpose of increasing the probability of acceptance. Such adjustments may be made on various bases.

In some embodiments, a quote, or proposal, may be adjusted based on product specs and hierarchy. For example, when the probability of a quote to be approved has been determined by the machine learning model 102 to be unacceptably low, the sales entity may set some constraints and try to adjust the quote to generate a higher probability.

For example, the sales entity may be able to define what products he would like to keep intact, that is, products whose configuration or characteristics will remain static, and which products can be changed. The sales entity may also define, for example, if one product should be replaced with a similar one in order to give further discount, if the sales entity would like to upgrade a certain product, or if the sales entity would like to simply try and increase the probability of acceptance without specifying whether or not the product should be upgraded/replaced.

Using any constraints specified by the sales entity, or otherwise applied, a search algorithm, which may be an element of the machine learning model 102, may be employed in an attempt to generate a revised quote with a relatively higher likelihood of acceptance by the target customer. Any of various different approaches may employed in the generation of a revised quote. One approach would be for the search algorithm to identify all possible options for modifying the initial quote. Suppose, for example, the sales entity would like to upgrade a certain laptop, but only up to a certain price. In this example, the framework may evaluate all available possibilities to modify the laptop configuration without exceeding that price. Such modification possibilities might include, for example, ({better RAM}, {better CPU}, and {better RAM, better CPU}). If each of these modifications, some of them, or all of them, could be implemented without exceeding the price constraint, the machine learning model 102 may determine the probability of acceptance for each modification, and then select the modification(s) that correspond to the highest probability of acceptance.

As another example, the search algorithm may consider various reconfiguration options in a serial manner. That is, the search algorithm may evaluate one possible change to the quote per iteration of a search, and check if the change that was made generated a high probability of acceptance or not. Continuing with the previous example, the option of including a better RAM may first be evaluated. If additional costs of upgrading the RAM fall within an acceptable range, the probability of acceptance will be determined, but if the RAM upgrade cost is not acceptable, another iteration may be performed to evaluate the advisability of, for example, upgrading the CPU. Note that the various upgrade options may all have the same relative weight, or different respective weights. Thus, for example, an option that exceeds the price constraint by a small amount, but is heavily weighted, may nonetheless be considered for inclusion in the quote. The weightings may be assigned by the customer entity and/or the sales entity.

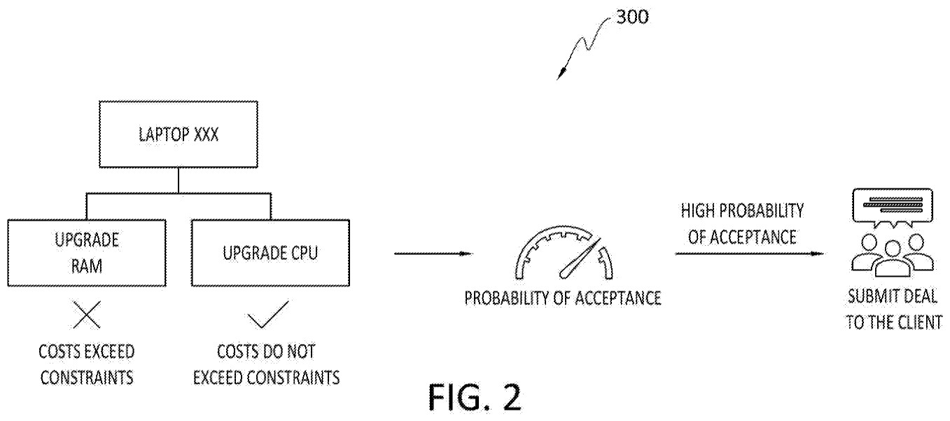

With reference now to FIG. 2, another illustrative example is provided. In the example scenario 300 of FIG. 2, upgrading the RAM would exceed the additional cost that was defined. On the other hand, upgrading the CPU would not exceed the additional cost and the probability of acceptance is high. Thus, in scenario 300, the quote may be revised to include a CPU upgrade, but may not be revised to include a RAM upgrade.

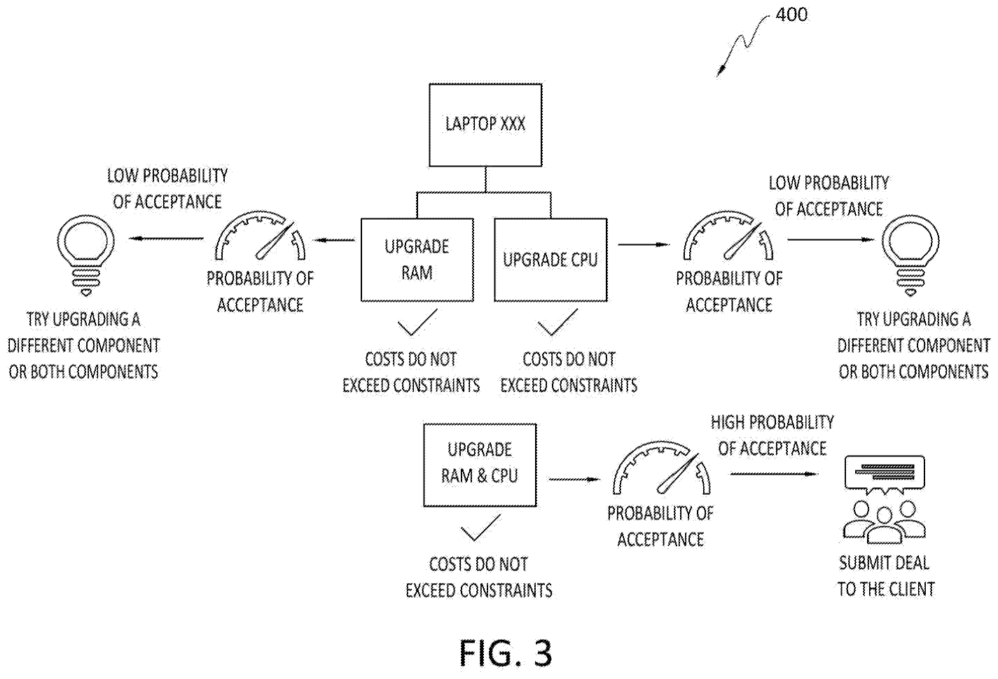

Turning next to FIG. 3, another example scenario 400 is indicated. In this example, upgrading the RAM in the quote does not exceed the additional costs. However, even with this upgrade, the probability of acceptance is still low, and likewise for a CPU upgrade. Since neither the RAM upgrade, nor the CPU upgrade, considered alone has a positive effect on the probability of acceptance, consideration may be given to determining how that probability might be affected if both upgrades were included in the quote. In this case, the new cost is still in the given range, and the probability of acceptance is high. Thus, the sales entity may update the quote to include both the RAM upgrade and the CPU upgrade.

The foregoing example scenarios concerned possible modifications to a quote based upon product specifications and an associated hierarchy. Some embodiments may additionally, or alternatively, provide for quote modifications based on historical data, such as historical data relating to the behavior of customers and/or prospective customers.

Collecting this kind of data, such as from e-commerce websites, may be accomplished using clickstream analysis, for example. From the collected data, samples may be extracted indicating where a prospective customer examined a certain product but eventually decided to buy a different one.

Another example is when there are two similar products in the shopping cart of a prospective customer, but eventually one is removed. Still another useful data source for this kind of behavior is the pricing data set, where a quote with a certain configuration is suggested to the customer, denied, and then followed by a different suggestion with a different configuration which gets approved by the customer.

After proposing alternative products to the product that is currently being suggested to the customer, constraints imposed by the sales entity may be introduced into the process to filter out irrelevant products. Next, the similarity between the current product and its alternatives may be examined. The similarity may be calculated, or otherwise determined, based on, for example, the specifications of the product, using cosine similarity and/or other techniques. It is noted that cosine similarity, and/or comparable techniques, may also be used to determine deal similarity, such as was discussed in connection with FIG. 1. After the similarity analysis has been performed, and similarity scores determined for the various products, a selected group, such as 3 for example, of the most similar products may be evaluated using the machine learning model 102, and the product that is determined to have the highest probability of acceptance may be proposed to the customer.

B.3 Further Points

In view of the present disclosure, it will be apparent that conventional approaches for adjusting a quote or proposal are flawed for a variety of reasons. For example, such adjustments are often based on little more than the intuition of a salesman as to whether or such not the adjustment will be accepted by a prospective consumer. As another example, a mis-assessment on the part of the salesman may result in a lost opportunity, such as a lost sale.

Finally, making adjustments to a proposal, while at the same time attempting to maintain an acceptable profit margin for the proposal, is a complex process that is beyond the ability of a human to do without introducing the possibility of human error, and also beyond the ability of a human to perform in a timely manner. Such embodiments may, for example, generate an updated quote and/or updated probability almost immediately, such as in about 5 seconds or less and possibly as quickly as about 1 second or less, after input relating to the updated quote and/or updated probability has been received. Thus, embodiments of the invention do not merely organize human behavior but, instead, such embodiments implement functionality that a human is not capable of performing, practically or in any way. Accordingly, such functionality is performed by a computing system, as disclosed herein.

At least some embodiments may, but do not necessarily, address such concerns by way of various functionalities. For example, at least some embodiments may create new/modified proposals on a systematic basis using factors other than, or in addition to, human intuition. As well, some embodiments may employ various types of historical data, and/or account characteristics, product specifications and hierarchies (see, e.g., FIGS. 2 and 3), as bases for creating a new/modified proposal with an acceptable probability of acceptance by a user. Further, some embodiments may provide for creation/modification of a proposal while maintaining a particular margin, which the sales entity may not be aware of, associated with the proposal. For example, the margin may be imposed by an accounting or other department at an enterprise, but not revealed to the sales personnel. As a final example, some embodiments of the invention may elevate customer satisfaction by quickly identifying a proposal with a high probability of acceptance.

### C. Example Methods

It is noted with respect to the example method of Figure(s) XX that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

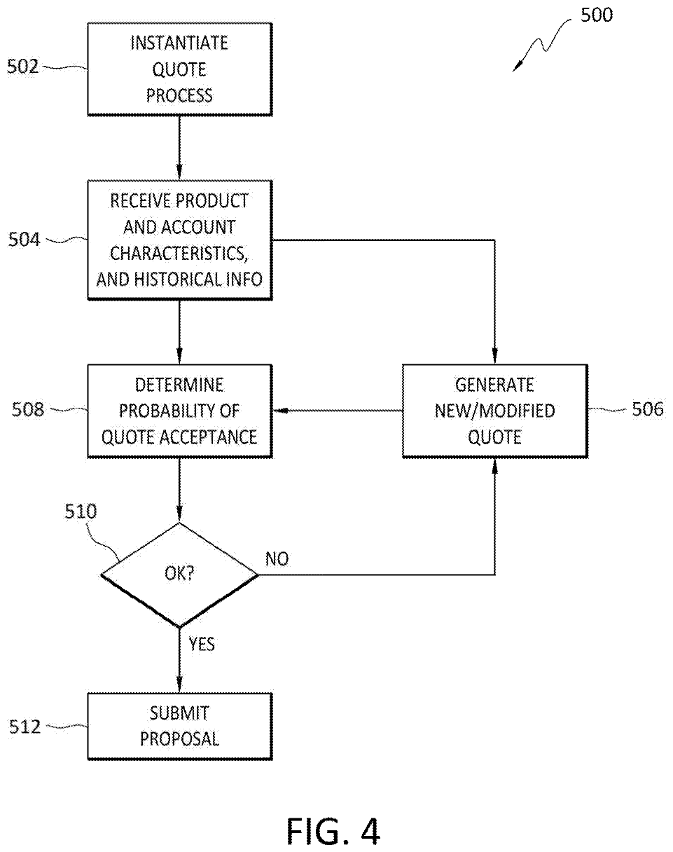

Directing attention now to FIG. 4, details are provided concerning methods and processes for generating a new or modified proposal, where one example of such a method is denoted generally at 500. The example method 500 may be performed in whole, or in party, by/at an enterprise, which may include a machine learning model, associated with which one or more sales entities are associated. In some cases, the example method 500 may be performed cooperatively by one or more sales entities and an enterprise. In some instances, the method 500 may be performed in whole or in part by a quotation platform that comprises, or consists of, a machine learning model. However, no particular implementation of the method 500 is required, and the foregoing are presented only by way of example.

The example method 500 may begin with instantiation, such as by a sales entity, of a quote process 502. The process 502 may involve, for example instantiation at a mobile device, or instantiation of a web app using a web browser. The sales entity or other user may then provide various input which may be received 504 by a quotation software platform or other entity. The input received 504 may comprise, for example, characteristics of one or more prior quotations that are similar in one or more respects to the quotation to be generated by the method 500, characteristics of an account for whom the quotation is to be generated, historical information concerning the prior quotations, particular users associated with the account, and/or the account itself.

Next, a new or modified quotation may be generated 506, such as by a sales entity for example, or automatically in some cases. The new/modified quotation may identify, for example, an account for whom the quotation was generated 506, the products/services proposed to be provided to the account, and the price associated with provision of those products/services. The quote may be generated, in whole or in part, based on the input received at 504, and may be configured so as to provide at least a specified profit margin if accepted by a customer. As well, the generated quote 506, whether new or modified, may serve as an input to a machine learning model which may then determine 508 the probability that the quote will be accepted by the customer. This determination 508 may be based, for example, on the input received at 504.

If the probability that the quote will be accepted is evaluated 510 as unacceptable, the method 500 may return to 506, and the quote modified in an attempt to improve the probability that the quote will be accepted by the customer. On the other hand, if the probability that the quote will be accepted is evaluate 510 as being acceptable, or acceptably high, the method 500 may advance to 512 where the quote is presented to the customer.

Regardless of whether the quote that is generated at 506 is determined 510 to have a sufficient probability of acceptance, that quote may be stored as historical data that may be used as an input 504, for example, to generate 506 one or more future quotes and/or as a basis for determining 508 the probability that a future quote will be accepted by a customer. The quote that is ultimately presented to the customer 512 may be employed in these same ways as well.

### D. Further Example Embodiments

Following are some further example embodiments of the invention. These are presented only by way of example and are not intended to limit the scope of the invention in any way.

Embodiment 1. A method, comprising: receiving a quote for provision of goods and/or services, and the quote concerns a particular account; receiving information concerning characteristics of the account identified in the quote; receiving information concerning characteristics of the goods and/or services specified in the quote; generating a probability that the quote will be approved by the account, and the probability is generated based on the characteristics of the account and the characteristics of the goods and/or services specified in the quote; when the probability is below a threshold, generating an adjusted quote based on input received; and generating an updated probability based on the adjusted quote.

Embodiment 2. The method as recited in embodiment 1, wherein part of the method is performed by a machine learning model.

Embodiment 3. The method as recited in any of embodiments 1-2, wherein the probability and/or updated probability are generated based on one or both of: a first deal cluster comprising a plurality of deals and identifying common quote characteristics among respective quotes that are associated with the deals; and/or a second deal cluster comprising a plurality of deals and identifying common account characteristics among respective accounts associated with the deals.

Embodiment 4. The method as recited in embodiment 3, further comprising assigning the updated quote to one of the deal clusters, and updating a ratio of approved deals associated with the deal cluster to which the updated quote is assigned.

Embodiment 5. The method as recited in any of embodiments 1-4, further comprising: presenting, to a user, possible modifications to goods and/or services specified in the quote; receiving, from the user, the input, and the input indicating selection of one or more of the modifications; generating the adjusted quote based on the input received from the user; and providing, to the user, the updated probability.

Embodiment 6. The method as recited in embodiment 5, wherein the modifications are presented in serial form, or hierarchical form.

Embodiment 7. The method as recited in any of embodiments 1-6, wherein the updated probability and/or the updated quote are generated almost immediately after receipt of the input from the user.

Embodiment 8. The method as recited in any of embodiments 1-7, further comprising: generating a first deal cluster comprising a plurality of deals and identifying common quote characteristics among respective quotes that are associated with the deals; and/or generating a second deal cluster comprising a plurality of deals and identifying common account characteristics among respective accounts associated with the deals, and generation of the updated probability is based on the characteristics identified in the first deal cluster and/or the characteristics identified in the second deal cluster.

Embodiment 9. The method as recited in any of embodiments 1-8, wherein a margin associated with the quote is maintained in the updated quote.

Embodiment 10. The method as recited in any of embodiments 1-9, wherein the updated probability is higher than the probability.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1 through 11.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

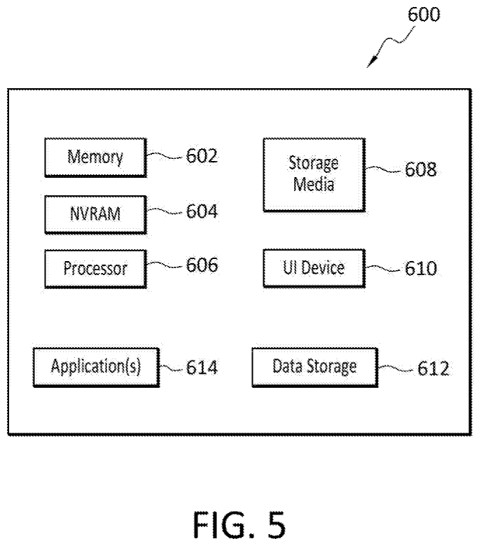

With reference briefly now to FIG. 5, any one or more of the entities disclosed, or implied, by FIGS. 1-4 and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 5.

In the example of FIG. 5, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a quote for provision of goods and/or services, and the quote concerns a particular account;
receiving information concerning characteristics of the account identified in the quote;
receiving information concerning characteristics of the goods and/or services specified in the quote;
generating a probability that the quote will be approved by the account, and the probability is generated based on the characteristics of the account and the characteristics of the goods and/or services specified in the quote;
when the probability is below a threshold, generating an adjusted quote based on input received; and
generating an updated probability based on the adjusted quote.

2. The method as recited in claim 1, wherein part of the method performed by a machine learning model.

3. The method as recited in claim 1, wherein the probability and/or updated probability are generated based on one or both of: a first deal cluster comprising a plurality of deals and identifying common quote characteristics among respective quotes that are associated with the deals; and/or a second deal cluster comprising a plurality of deals and identifying common account characteristics among respective accounts associated with the deals.

4. The method as recited in claim 3, further comprising assigning the updated quote to one of the deal clusters, and updating a ratio of approved deals associated with the deal cluster to which the updated quote is assigned.

5. The method as recited in claim 1, further comprising:
presenting, to a user, possible modifications to goods and/or services specified in the quote;
receiving, from the user, the input, and the input indicating selection of one or more of the modifications;
generating the adjusted quote based on the input received from the user; and
providing, to the user, the updated probability.

6. The method as recited in claim 5, wherein the modifications are presented in serial form, or hierarchical form.

7. The method as recited in claim 1, wherein the updated probability and/or the updated quote are generated almost immediately after receipt of the input from the user.

8. The method as recited in claim 1, further comprising:
generating a first deal cluster comprising a plurality of deals and identifying common quote characteristics among respective quotes that are associated with the deals; and/or
generating a second deal cluster comprising a plurality of deals and identifying common account characteristics among respective accounts associated with the deals,
and generation of the updated probability is based on the characteristics identified in the first deal cluster and/or the characteristics identified in the second deal cluster.

9. The method as recited in claim 1, wherein a margin associated with the quote is maintained in the updated quote.

10. The method as recited in claim 1, wherein the updated probability is higher than the probability.

11. A non-transitory storage medium having stored therein instructions that are executable by one or more hardware processors to perform operations comprising:
receiving a quote for provision of goods and/or services, and the quote concerns a particular account;
receiving information concerning characteristics of the account identified in the quote;
receiving information concerning characteristics of the goods and/or services specified in the quote;
generating a probability that the quote will be approved by the account, and the probability is generated based on the characteristics of the account and the characteristics of the goods and/or services specified in the quote;
when the probability is below a threshold, generating an adjusted quote based on input received; and
generating an updated probability based on the adjusted quote.

12. The non-transitory storage medium as recited in claim 11, wherein one or more of the operations are performed by a machine learning model.

13. The non-transitory storage medium as recited in claim 11, wherein the probability and/or updated probability are generated based on one or both of: a first deal cluster comprising a plurality of deals and identifying common quote characteristics among respective quotes that are associated with the deals; and/or a second deal cluster comprising a plurality of deals and identifying common account characteristics among respective accounts associated with the deals.

14. The non-transitory storage medium as recited in claim 13, wherein the operations further comprise assigning the updated quote to one of the deal clusters, and updating a ratio of approved deals associated with the deal cluster to which the updated quote is assigned.

15. The non-transitory storage medium as recited in claim 11, wherein the operations further comprise:
presenting, to a user, possible modifications to goods and/or services specified in the quote;
receiving, from the user, the input, and the input indicating selection of one or more of the modifications;
generating the adjusted quote based on the input received from the user; and
providing, to the user, the updated probability.

16. The non-transitory storage medium as recited in claim 15, wherein the modifications are presented in serial form, or hierarchical form.

17. The non-transitory storage medium as recited in claim 11, wherein the updated probability and/or the updated quote are generated almost immediately after receipt of the input from the user.

18. The non-transitory storage medium as recited in claim 11, wherein the operations further comprise:
generating a first deal cluster comprising a plurality of deals and identifying common quote characteristics among respective quotes that are associated with the deals; and/or
generating a second deal cluster comprising a plurality of deals and identifying common account characteristics among respective accounts associated with the deals,
and generation of the updated probability is based on the characteristics identified in the first deal cluster and/or the characteristics identified in the second deal cluster.

19. The non-transitory storage medium as recited in claim 11, wherein a margin associated with the quote is maintained in the updated quote.

20. The non-transitory storage medium as recited in claim 11, wherein the updated probability is higher than the probability.
